(19) United States
(12) Patent Application Publication
(10) Pub. No.: US 2020/0055098 A1
(43) Pub. Date: Feb. 20, 2020

(54) METHODS AND APPARATUS FOR MANUFACTURING A WEB

(71) Applicant: CORNING INCORPORATED, CORNING, NY (US)

(72) Inventors: Todd Benson Fleming, Elkland, PA (US); Gautam Narendra Kudva, Horseheads, NY (US); Dale Charles Marshall, Brockport, NY (US); Eric Lee Miller, Corning, NY (US); Robert Daniel Parker, Beaver Dams, NY (US); Calvin Jay Winder, Cromwell, CT (US); John Anthony Yorio, Elmira, NY (US)

(21) Appl. No.: 16/342,812

(22) PCT Filed: Oct. 20, 2017
(86) PCT No.: PCT/US2017/057570

§ 371 Date: Apr. 17, 2019

Related U.S. Application Data
(60) Provisional application No. 62/410,616, filed on Oct. 20, 2016.

(51) Int. Cl. B08B 5/04; B08B 5/02

(52) U.S. Cl. CPC B08B 5/046; B08B 5/026

(57) ABSTRACT

A web conveyance apparatus (101) may comprise a first cleaning device (136) with a first exterior suction port (211) laterally positioned outside of a first edge (201a) and facing a footprint (204a) of a first major surface (203a) of a web (103). In further embodiments, a method of manufacturing a web (103) may comprise conveying the web along a direction of a conveyance path and suctioning particles from the first major surface (203a) with a first exterior suction port (211) laterally positioned outside of a first edge (201a) and facing a footprint (204a) of a first major surface (203a) while conveying the web.

### CROSS-REFERENCE TO RELATED APPLICATIONS

This application claims the benefit of priority under 35 U.S.C. § 119 of U.S. Provisional Application Ser. No. 62/410,616 filed on Oct. 20, 2016, the content of which is relied upon and incorporated herein by reference in its entirety.

### FIELD

The present disclosure relates generally to methods and apparatus for manufacturing or conveying a web and, more particularly, to methods of manufacturing or conveying a web comprising suctioning particles and apparatus for manufacturing or conveying a web comprising a cleaning device with an exterior suction port.

### BACKGROUND

Glass sheets are commonly used, for example, in display applications, for example liquid crystal displays (LCDs), electrophoretic displays (EPD), organic light emitting diode displays (OLEDs), plasma display panels (PDPs), or the like. Glass sheets are commonly fabricated by a flowing molten glass to a forming body whereby a glass web may be formed by a variety of web forming processes, for example, slot draw, float, down-draw, fusion down-draw, rolling, tube drawing, or up-draw. Edge portions of the glass web may be separated from a central portion of the glass web and/or the glass web may be periodically separated into individual glass sheets.

During glass production, conveyance, and/or separation processes, particles (e.g., pull roll debris, dust, glass shards, glass chips and other particles) frequently land on one of the major glass surfaces while the glass web is being conveyed during a glass forming process and/or other glass manufacturing process. There is a desire to quickly remove the particles before these particles firmly attach to or otherwise damage the major surfaces of the glass web.

It is known to suction particles from the surface of a glass sheet by placing a suction port facing perpendicularly to the major surface of the glass sheet within the footprint of the major surface being cleaned; this type of suction port may be referred to as an “interior suction port”. During typical cleaning operations, a gas jet emitting from a gas nozzle is typically designed to impact the major surface being cleaned along a direction perpendicular to the major surface being cleaned. When the conventional gas nozzle and interior suction port are operated together, the gas nozzle may separate particles from the major surface being cleaned, and relatively large particles may then be vertically lifted to be received by the interior suction port. However, the interior suction port may not be as effective in vertically lifting and thereafter removing small particles (i.e., particles having a maximum dimension of from 20 microns to 100 microns). Indeed, small particles separated from the major surface of the glass sheet tend to remain entrained in the gas jet rather than being drawn into the interior suction port. Such small particles may eventually fall out of the gas jet and be redeposited on the major surface of the glass web. Redeposited glass particles on the major surface of the glass web can permanently attach themselves to the glass web or otherwise damage the glass web. For instance, a glass web may be tightly coiled onto a storage roll where the redeposited particles may be permanently attached to the major surface of the glass web and/or scratch or otherwise damage the pristine surface of the glass web as a consequence of being pressed against the glass web. Consequently, there is a need to more efficiently remove particles, particularly small particles, from the major surfaces of a web (e.g., glass ribbon, glass sheet). There is a further need to quickly remove the particles from the major surfaces of the web prior to the particles attaching to the web or otherwise damaging the web. Still further, there is a need to remove particles in-line and prior to packaging the web (e.g., as a tightly coiled glass ribbon or a stack of glass sheets) to avoid pressing the particles against the major surface of the glass web.

### SUMMARY

There are set forth methods and apparatus that more efficiently remove particles, including small particles (i.e., particles having a maximum dimension of from 20 microns to 100 microns), that may be redeposited on a major surface of a web during processing of the web. Features of the disclosure orient some suction ports as laterally positioned outside of an edge of a web and facing a footprint of a major surface of the web, these are also called “exterior suction ports”. Such positioning can allow the exterior suction ports to be placed within a travel path of the gas stream, thereby capturing particles entrained in the gas stream without having to change the travel path of the entrained particles. Consequently, the lateral exterior suctioning can more efficiently remove relatively small particles compared to conventional interior suctioning techniques that may not be effective to divert entrained particles from the gas stream into a diverted travel direction toward an interior suction port that faces perpendicularly to the major surface of the web and within a footprint of the web.

Some example embodiments of the disclosure are described below with the understanding that any of the embodiments may be used alone or in combination with one another.

### Embodiment 1

A web conveyance apparatus may comprise a web conveyance path and a first cleaning device. The web conveyance path may comprise a first edge, a second edge, a first major surface extending between the first edge and the second edge, a second major surface extending between the first edge and the second edge, a width defined between the first edge and the second edge, and a thickness defined between the first major surface and the second major surface. The first cleaning device may comprise a first exterior suction port laterally positioned outside of the first edge and facing a footprint of the first major surface.

### Embodiment 2

The web conveyance apparatus of embodiment 1 where the first cleaning device may further comprise a second exterior suction port laterally positioned outside of the second edge and facing the footprint of the first major surface.

### Embodiment 3

The web conveyance apparatus of any one of embodiments 1 and 2, where the first cleaning device may further comprise a first gas knife segment. The first gas knife segment may comprise a first gas knife port facing a first gas knife direction that is a first resultant vector of a first surface vector extending towards the first major surface and perpendicularly to the first major surface and a second surface vector that is perpendicular to the first surface vector and extends toward the first edge, and the second surface vector intersects, at a first acute angle, a line parallel to the first edge.

### Embodiment 4

The web conveyance apparatus of embodiment 3, where the first cleaning device may further comprise a second gas knife segment. The second gas knife segment may comprise a second gas knife port facing a second gas knife direction that is a second resultant vector of the first surface vector and a third surface vector that is perpendicular to the first surface vector and extends toward the second edge, and the third surface vector intersects, at a second acute angle, a line parallel to the second edge.

### Embodiment 5

The web conveyance apparatus of any one of embodiments 1 and 2, where the first cleaning device may further comprise a first gas knife segment and a second gas knife segment. The first gas knife segment may comprise a first gas knife port extending along a first gas knife axis. The second gas knife segment may comprise a second gas knife port extending along a second gas knife axis. An interior angle of from greater than 0° to less than 180° may be defined between the first gas knife axis and the second gas knife axis.

### Embodiment 6

The web conveyance apparatus of embodiment 5, where the interior angle may face a downstream direction of a conveyance path defined by the web conveyance apparatus.

### Embodiment 7

The web conveyance apparatus of any one of embodiments 1-6, where the first exterior suction port may comprise a plurality of first exterior suction ports extending along the first edge.

### Embodiment 8

The web conveyance apparatus of embodiment 7, where each suction port of the plurality of first exterior suction ports may be positioned on a common axis that is parallel to the first edge and laterally offset outside of the first edge.

### Embodiment 9

The web conveyance apparatus of any one of embodiments 1-8, where a lateral footprint of a length of the first edge may be positioned entirely within a footprint of the first exterior suction port.

### Embodiment 10

The web conveyance apparatus of any one of embodiments 1-9, further comprising a second cleaning device. The second cleaning device may include an interior suction port laterally positioned between the first edge and the second edge within the footprint of the first major surface.

### Embodiment 11

The web conveyance apparatus of any one of embodiments 1-10, further comprising a static neutralizing device. The static neutralizing device may be positioned to neutralize a static charge of at least one of the web and particles on the first major surface of the web.

### Embodiment 12

The web conveyance apparatus of any one of embodiments 1-11, where the web may comprise glass.

### Embodiment 13

The web conveyance apparatus of any one of embodiments 1-12, where the thickness of the web may be from about 50 microns to about 300 microns.

### Embodiment 14

A method of manufacturing a web. The web may comprise a first edge, a second edge, a first major surface extending between the first edge and the second edge, a second major surface extending between the first edge and the second edge, a width defined between the first edge and the second edge, and a thickness defined between the first major surface and the second major surface. The method may comprise conveying the web along a direction of a conveyance path. The method may further comprise suctioning particles from the first major surface, with a first exterior suction port laterally positioned outside of the first edge and facing a footprint of the first major surface, while conveying the web.

### Embodiment 15

The method of embodiment 14, further comprising suctioning additional particles from the first major surface, with a second exterior suction port laterally positioned outside of the second edge and facing the footprint of the first major surface, while conveying the web.

### Embodiment 16

The method of any one of embodiments 14 and 15, where, prior to suctioning the particles, the method may comprise separating the particles from the first major surface with a first knife of gas. The first knife of gas may face a first gas knife direction that is a first resultant vector of a first surface vector extending towards the first major surface and perpendicularly to the first major surface and a second surface vector that is perpendicular to the first surface vector and that extends toward the first edge, and the second surface vector intersects, at a first acute angle, a line parallel to the first edge.

### Embodiment 17

The method of embodiment 16, where, prior to suctioning the additional particles, the method may comprise separating the additional particles from the first major surface with a second knife of gas. The second knife of gas may face a second gas knife direction that is a second resultant vector of the first surface vector and a third surface vector that is perpendicular to the first surface vector and that extends toward the second edge, and the third surface vector intersects, at a second acute angle, a line parallel to the second edge.

### Embodiment 18

The method of any one of embodiments 14-17, further comprising suctioning additional particles from the second major surface.

### Embodiment 19

The method of embodiment 18, where the suctioning of the particles from the first major surface and the suctioning of additional particles from the second major surface may be conducted simultaneously with the first exterior suction port.

### Embodiment 20

The method of any one of embodiments 14-19, further comprising neutralizing a static charge of at least one of the web and the particles.

### Embodiment 21

The method of any one of embodiments 14-20, where the web may comprise glass.

### Embodiment 22

The method of any one of embodiments 14-21, where the thickness of the web is from about 50 microns to about 300 microns.

### Embodiment 23

A method of manufacturing a web. The web may comprise a first edge, a second edge, a first major surface extending between the first edge and the second edge, a second major surface extending between the first edge and the second edge, a width defined between the first edge and the second edge, and a thickness defined between the first major surface and the second major surface. The method may comprise conveying the web along a direction of a conveyance path. The method may further comprise suctioning particles from a portion of the web with an interior suction port laterally positioned between the first edge and the second edge within a footprint of the first major surface while conveying the web. The method may further comprise conveying the portion of the web along the direction of the conveyance path to an exterior suction port laterally positioned outside of the first edge and facing the footprint of the first major surface. The method may further comprise suctioning additional particles from the portion of the web with the exterior suction port.

### Embodiment 24

The method of embodiment 23, where, prior to suctioning particles from the portion of the web with the interior suction port, the method may comprise separating an edge portion of the web to create the first edge.

### BRIEF DESCRIPTION OF THE DRAWINGS

The above and other features and advantages of embodiments of the present disclosure are better understood when the following detailed description is read with reference to the accompanying drawings, in which:

FIG. 1 is a schematic view of an apparatus for manufacturing web in accordance with embodiments of the disclosure;

FIG. 2 is a cross-sectional view of the apparatus along line 2-2 of FIG. 1;

FIG. 3 is an enlarged view taken at view 3 of FIG. 2;

FIG. 4 is a cross-sectional view of the apparatus along line 4-4 of FIG. 1;

FIG. 5 is a cross-sectional view of the apparatus along line 5-5 of FIG. 2;

FIG. 6 is a cross-sectional view of another embodiment of the apparatus along line 5-5 of FIG. 2;

FIG. 7 a cross-sectional view of the apparatus along line 7-7 of FIG. 2; and

FIG. 8 a cross-sectional view of the apparatus along line 8-8 of FIG. 2.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, claims may encompass many different aspects of various embodiments and should not be construed as limited to the embodiments set forth herein.

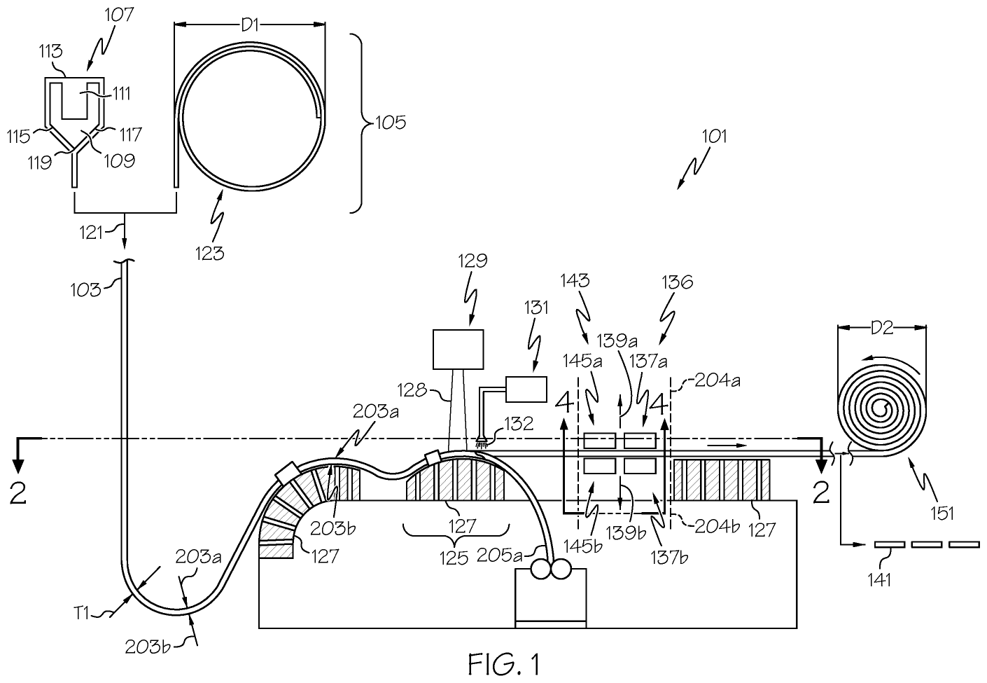

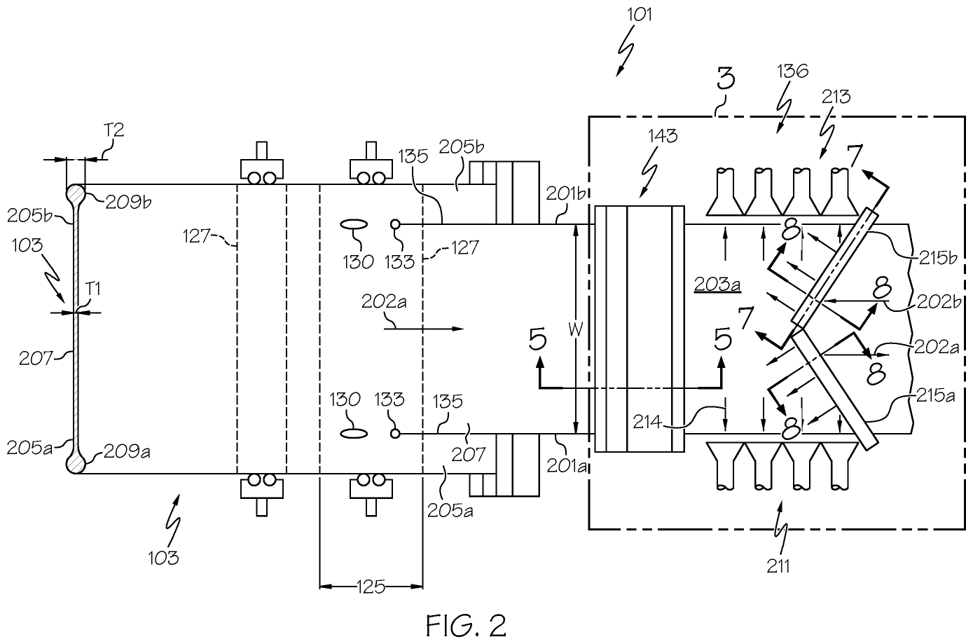

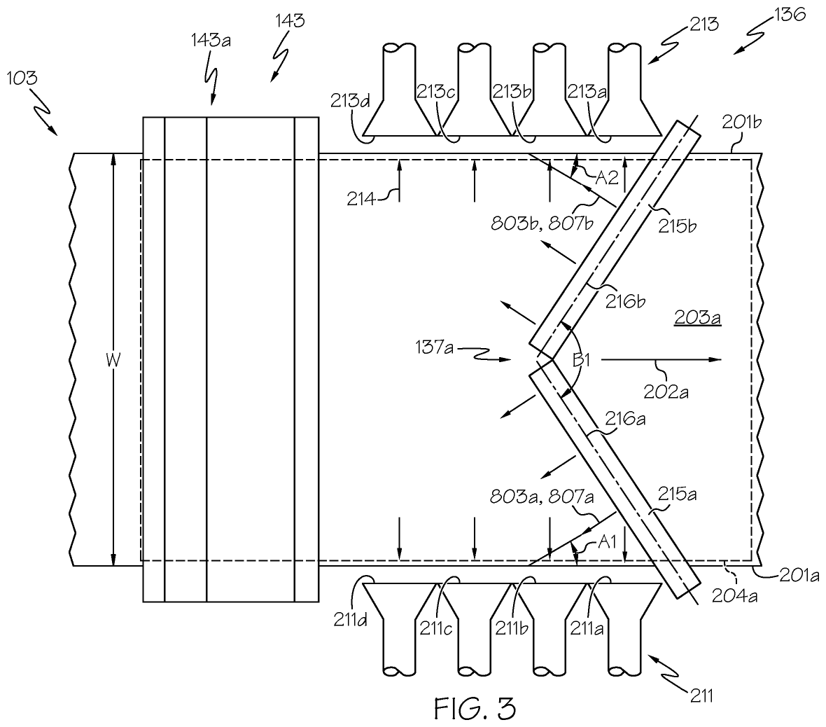

FIG. 1 illustrates a web conveyance apparatus 101 for fabricating a web 103. Referring to FIG. 2 the web 103 may include a first edge 201a and a second edge 201b opposed to the first edge 201a. As shown, in some embodiments, the first edge 201a and the second edge 201b may include straight edges although the edges may be curved, stepped or be provided with other profiles in further embodiments. Still further, as shown, the first edge 201a and the second edge 201b can be substantially parallel to one another although angled edges may be provided in further embodiments. As shown in FIGS. 2-3, a width “W” may be defined between the first edge 201a and the second edge 201b. In the illustrated embodiment, the width “W” may be substantially constant along a length in a travel direction 202a although the width may vary along the travel direction 202a in further embodiments. For instance, as shown, the first edge 201a and the second edge 201b may comprise substantially straight and parallel edges with a substantially constant width “W” along a length in the travel direction 202a. In some embodiments, the travel direction 202a may comprise a direction of relative movement of one of the web 103 and portions of the web conveyance apparatus 101 with respect to the other of the web 103 and the portions of the web conveyance apparatus 101. In the embodiment shown in FIG. 2, the web 103 may travel along the travel direction 202a relative to portions of the web conveyance apparatus 101. Although not shown, portions of the glass manufacturing apparatus may travel along a travel direction 202b relative to a stationary web 103. In some embodiments, the width “W” may be from about 10 millimeters (mm) to about 3 meters (m) although other widths may be provided in further embodiments. In some embodiments, the width “W” may be ≥20 mm, ≥50 mm, ≥100 mm, ≥500 mm, or ≥1 m.

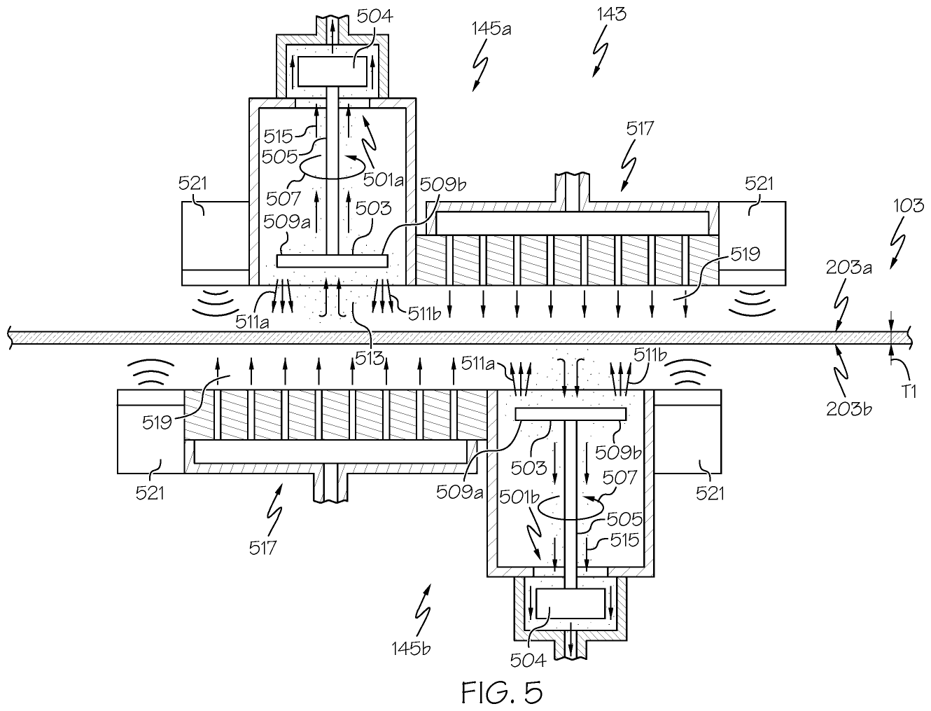

The web 103 can further include a first major surface 203a extending between the first edge 201a and the second edge 201b and a second major surface 203b extending between the first edge 201a and the second edge 201b. As shown, the first edge 201a and the second edge 201b can define outermost lateral boundaries of the first and second major surfaces 203a-b. In some embodiments, the first and second major surfaces 203a-b may be substantially flat or curved. Furthermore, the substantially flat or curved first and second major surfaces 203a-b may be substantially parallel to one another and offset from one another by a thickness “T1” defined between the first major surface 203a and the second major surface 203b. Indeed, as shown in the embodiment illustrated in FIGS. 5-8, a thickness “T1” may be defined between the first major surface 203a and the second major surface 203b that are parallel to one another at a portion of the web 103 that is substantially flat. As shown in FIG. 1, in applications comprising a flexible web 103, for example, the illustrated flexible glass ribbon in FIG. 1, a curved portion of the web 103 may further include curved and parallel first and second major surfaces 203a-b that are also offset from one another by the thickness “T1”. In some embodiments, the thickness T1” may be of the web 103 may be from about 50 microns to about 500 microns or from about 50 microns to about 300 microns. For instance, in some embodiments, the web 103 may have a thickness of ≤500 microns, ≤300 microns, ≤200 microns, or ≤100 microns.

The web 103 may be fabricated from a wide range of materials, for example, silicon, plastic, resin, ceramic, glass-ceramic, glass or other materials. In some embodiments, the web may comprise a flexible material, for example, flexible glass. In some embodiments, the web may include glass including but not limited to soda-lime glass, borosilicate glass, alumino-borosilicate glass, alkali-containing glass or alkali-free glass. In some embodiments, the web 103 can include glass with a coefficient of thermal expansion of ≤15 ppm/° C., ≤10 ppm/° C., or ≤5 ppm/° C.

The web 103 may be provided by a wide range of sources. FIG. 1 illustrates two example sources 105 of web 103 although other sources may be provided in further examples. For instance, as shown in FIG. 1, the source 105 of web 103 can comprise a web forming apparatus 107. For instance, as schematically shown, the web forming apparatus 107 can include this illustrated down draw glass forming apparatus in applications where the web 103 comprises a glass ribbon. In further embodiments, if a glass web is desired, other glass web forming apparatus may be provided including but not limited to, up-draw, float, fusion, press rolling, or slot draw glass forming techniques.

By way of illustration, the down draw glass forming apparatus 107, if provided, can include a forming wedge 109 at the bottom of a trough 111. In operation, molten material 113, for example glass, can overflow the trough 111 and flow down opposite sides 115, 117 of the forming wedge 109. The two sheets of molten glass are subsequently fused together as they are drawn off the root 119 of the forming wedge 109. As such, the molten material may be formed as a web 103 comprising the illustrated glass ribbon that may be fusion down drawn to traverse in a downstream processing direction 121 off the root 119 of the forming wedge 109. The web 103 (e.g., glass ribbon) may have a speed, as it traverses along a travel direction 202a, of from about 50 millimeters/second (mm/s) to about 1 meter/second, for example. In some embodiments, the speed of the web 103 can be ≥50 mm/s, ≥100 mm/s, or ≥500 mm/s.

As shown by the cross section of FIG. 2, the web 103 can include a pair of opposed edge portions 205a-b and a central portion 207 spanning between the opposed edge portions 205a-b. Due to the down draw fusion process, the edge portions 205a-b of the web 103 may have corresponding edge beads 209a-b with a thickness “T2” that is greater than a thickness “T1” of the central portion 207 of the web 103.

Turning back to FIG. 1, another example source 105 of web 103 can comprise a coiled spool 123 of ribbon (e.g., glass ribbon). For example, a glass ribbon may be wound into the coiled spool 123 after being drawn into a glass ribbon from a quantity of molten material, for example, with the down draw glass forming apparatus 107. The glass ribbon of the coiled spool 123 may or may not have the illustrated edge beads 209a-b. However, if the greater thickness of the edge beads 209a-b are present, they may increase the minimum bend radius that avoids cracking or breaking the glass ribbon. As such, if coiled, the glass ribbon may be coiled with a relatively large bend radius such that a given length of glass ribbon would use a coiled spool 123 with a relatively large diameter “D1”. Thus, if the source 105 comprises the coiled spool 123 of web 103, the web 103 (e.g., glass ribbon) may be uncoiled from the coiled spool 123 to traverse in a downstream processing direction 121. As shown, in some embodiments, the downstream direction 121 may comprise the direction of gravity although the downstream processing direction 121 can include a lateral downstream direction traveling at an angle (e.g., perpendicular) to gravity depending on the source of the web 103 and/or configuration of the web conveyance apparatus 101.

As illustrated above, the source 105 can either produce or create a web 103 comprising the illustrated glass ribbon or other ribbon. Although not shown, the web 103 can alternatively comprise a glass sheet that has a length that is perpendicular to the width “W” of the glass sheet. In some examples, the length can be anywhere from greater than equal to ¼ of the width “W” of the glass sheet to six times the width “W” although other relative length/width ratios may be provided in further embodiments.

Web conveyance apparatus may include one or more optional separation zones designed to remove portion(s) of the web and/or separate a larger web into smaller webs. For instance, in the illustrated down draw forming apparatus 107, the opposed edge beads 209a-b are not of high optical quality and can prevent the web from achieving a desired bend radius when rolled into a roll of ribbon. As such, some embodiments involve a manufacturing step of separating and removing the opposed edge portions 205a-b, including the edge beads, from the high-quality central portion 207. FIG. 1 schematically illustrates a separation zone 125 that removes the opposed edge portions 205a-b that include the edge beads 209a-b. Although not required, in some embodiments, the web 103 may travel in a horizontal direction wherein, for example, one or more air bars 127 may be employed to float the web 103 on a cushion of air to prevent mechanical contact between the air bars 127 and the web 103. Indeed, the pristine first and second major surfaces 203a-b of the central portion 207 may be maintained as the cushion of air prevents scratching, chipping, cracking or other damage that may otherwise occur if the major surfaces were supported with support members that mechanically contact the major surfaces of the web.

The separation zone 125, if provided, can separate the web 103 (e.g., glass sheet or glass ribbon) to remove portions of the web and/or to otherwise divide the web. For instance, by way of example, both of the edge portion 205a-b may be separated from the central portion 207 of the web 103 although a single edge portion may be separated in further embodiments. Still further, in some embodiments, the web 103 may be separated into smaller pieces. In one embodiment, the web 103 may be separated along a direction perpendicular to the travel direction 202a or at an angle relative to the travel direction 202a that is not in the travel direction 202a. For instance, if the web 103 includes the illustrated glass ribbon, the glass ribbon may be separated in a direction of the width “W” that is perpendicular to the travel direction 202a in order to separate (e.g., periodically separate), one or more glass sheets from the glass ribbon. In further embodiments, as shown in FIG. 1, a high quality central portion of the glass ribbon may be separated to provide a plurality of high quality sheets 141. In still further embodiments, if the web 103 is provided as a glass sheet, the glass sheet may be separated into sub-sheets of a desired size in a direction of the length or width of the glass sheet or other direction of the glass sheet. Alternatively, as shown in FIG. 1, the web 103 may be coiled into a roll 151. As the edge portions 205a-b have been removed, the roll 151 may be more tightly wound into a diameter “D2” that is less than the diameter “D1” of the source of the web 103.

The separation zone 125 may include a wide range of separation devices designed to separate the web 10. By way of illustration, the separation device can include a laser device 129 and a coolant device 131. The laser device can produce a laser beam 128 that may impact the first major surface 203a of the web 103 at a laser beam spot 130 (see FIG. 2). The laser beam spot 130 can comprise an elliptical spot that has a major axis extending in the travel direction 202a to maximize heating along a desired path of separation. The coolant device 131 includes a coolant jet 132 that impacts the first major surface 203a of the web 103 at a coolant spot 133 that follows the laser beam spot 130, thereby quenching the portion of the first major surface 203a that was previously heated by the laser beam 128. Thermal shock from quenching with the coolant jet 132 can generate a full body crack 135 extending between the first and second major surface 203a-b to separate the web 103.

During the glass manufacturing, conveyance, and/or separation process, if provided, undesired particles may be generated such as web shards, web chips (e.g., glass shards, glass chips) or other particles may land on a major surface 203a-b of the web 103. In addition or alternatively, environmental debris, for example, dust, dirt or other environmental particles may land on a major surface 203a-b of the web 103. In still further examples, processing debris, for example, pull roll debris or other particles from the glass manufacturing process may land on a major surface 203a-b of the web 103.

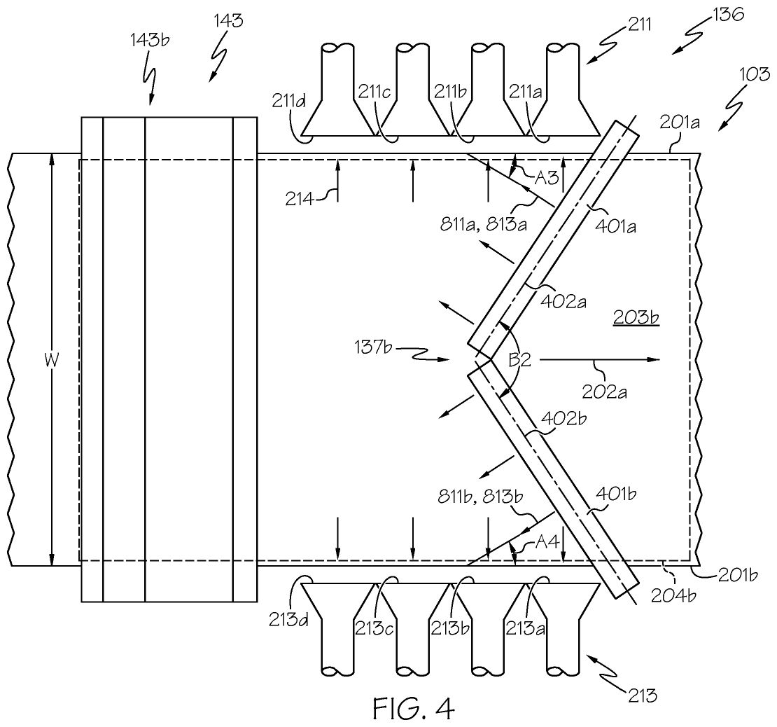

Throughout the disclosure, a footprint of a major surface of the web 103 (or of a web conveyance path for conveying the web in a conveyance apparatus) is a projection of a surface area of the major surface, bound by first and second edges 201a-b, in a direction facing away and perpendicularly to the major surface. Thus, as shown in dashed lines in FIGS. 1 and 3, the footprint 204a of the first major surface 203a of the web 103 is the projection of a surface area of the first major surface 203a, bound by the first and second edges 201a-b, in a direction 139a extending away from and perpendicularly to the first major surface 203a. Furthermore, as shown in dashed lines in FIGS. 1 and 4, the footprint 204b of the second major surface 203b of the web 103 is the projection of a surface area of the second major surface 203b, bound by the first and second edges 201a-b, in a direction 139b extending away from and perpendicularly to the second major surface 203b.

There is a desire to quickly remove any such contaminating particles from the major surface(s) 203a-b of the web 103 before such particles have the opportunity to adhere (e.g., permanently adhere) or otherwise damage the major surface(s) 203a-b of the web 103. In one embodiment, the web conveyance apparatus 101 can include a first cleaning device 136 that may include a first major surface cleaning device 137a to clean the first major surface 203a of the web 103 and/or a second major surface cleaning device 137b to clean the second major surface 203b of the web 103. As shown in FIGS. 2 and 3, the first cleaning device 136 may include a first exterior suction port 211 laterally positioned outside of the first edge 201a and facing a footprint 204a of the first major surface 203a of the web 103. In some embodiments, the entire first exterior suction port 211 can be located entirely outside of the width “W” of the web. In some embodiments, the first exterior suction port 211 may face the footprint 204a of the first major surface 203a, a footprint 204b of the second major surface 203b, and first edge 201a.

In some embodiments, the first cleaning device 136 may also include a second exterior suction port 213 laterally positioned outside of the second edge 201b and facing the footprint 204a of the first major surface 203a of the web 103. In the illustrated embodiment, the first exterior suction port 211 can be identical to the second exterior suction port 213 although different configurations may be used in further embodiments. Still further, as shown, the second exterior suction port 213 may comprise a mirror image of the first exterior suction port along a central axis of the central portion 207 of the web 103. In some embodiments, the entire second exterior suction port 213 can be located entirely outside of the width “W” of the web. In some embodiments, the second exterior suction port 213 may face the footprint 204a of the first major surface 203a, the footprint 204b of the second major surface 203b, and second edge 201b. As shown in FIGS. 2 and 3, in some embodiments, the entire width “W” of the web 103 may be located laterally between the first exterior suction port 211 and the second exterior suction port 213.

As shown, the first exterior suction port 211 and the second exterior suction port 213 may be identical to one another although different configurations may be provided in further embodiments.

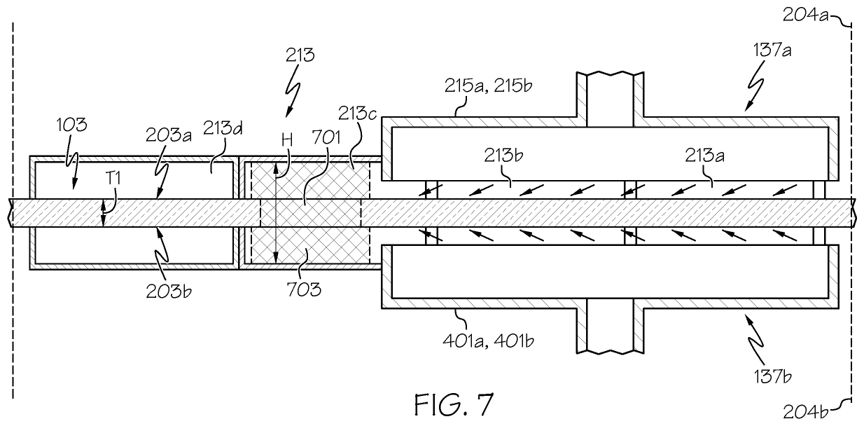

The footprint of the edge of the web 103 is a projection of the thickness “T1” of the web from the edge in a direction of the width of the web 103. For instance, as shown in FIG. 7, a lateral footprint 701 of a length of the first edge is positioned entirely within a footprint 703 of the first exterior suction port. Throughout the disclosure a footprint of an exterior suction port is considered the projection of the inlet area of the suction port taken along a section perpendicular to a port flow path 214 (See FIG. 3) that air travels along to be received by the exterior suction port in use. As further shown in FIG. 7, the thickness “T1” of the web 103 can be less than a height “H” of the first and second exterior suction port 211, 213. In alternative embodiments, the first exterior suction port 211 and/or the second exterior suction port 213 may each be divided to have and first and second offset suction port. For instance, with reference to FIG. 7, the illustrated second exterior suction port 213 may be divided with at least one suction port portion that faces the footprint 204a without facing the footprint 204b and at least one suction port portion that faces the footprint 204b without facing the footprint 204a.

In some embodiments, the first exterior suction port 211 may comprise a single suction port extending along the first edge 201a of the web 103. In alternative embodiments, as shown, the first exterior suction port 211 can comprise a plurality of first exterior suction ports 211a-d extending along the first edge 201a. Providing the first exterior suction port 211 as a plurality of first exterior suction ports 211a-d can help customize suction profiles of the first exterior suction port 211. Indeed, each suction port of the plurality of first exterior suction ports 211a-d may have a selected suction rate for advantageous particle capture or for accommodating alternative configurations. Furthermore, in some embodiments, each first exterior suction port of the plurality of first exterior suction ports 211a-d may optionally be positioned along a common axis. In some embodiments, the common axis may be parallel to the first edge 201a and, in some embodiments, may be offset to the outside of the first edge 201a to provide clearance for slight lateral shifting of the web 103 without the first edge 201a inadvertently contacting the first exterior suction port 211.

In some embodiments, the second exterior suction port 213 may comprise a single suction port extending along the second edge 201b of the web 103. In alternative embodiments, as shown, the second exterior suction port 213 can comprise a plurality of second exterior suction ports 213a-d extending along the second edge 201b. Providing the second exterior suction port 213 as a plurality of second exterior suction ports 213a-d can help customize suction profiles of the second exterior suction port 213. Indeed, each suction port of the plurality of second exterior suction ports 213a-d may have a selected suction rate for advantageous particle capture or for accommodating alternative configurations. Furthermore, in some embodiments, each first exterior suction port of the plurality of second exterior suction ports 213a-d may optionally be positioned along a common axis. In some embodiments, the common axis may be parallel to the second edge 201b and, in some embodiments, may be offset to the outside of the second edge 201b to provide clearance for slight lateral shifting of the web 103 without the second edge 201b inadvertently contacting the second exterior suction port 213.

As shown in FIGS. 1 and 3, the first cleaning device 136 can include a first major surface cleaning device 137a. In addition or alternatively, as shown in FIGS. 1 and 4, the first cleaning device 136 can include a second major surface cleaning device 137b. In the illustrated embodiment, the first major surface cleaning device 137a may be identical to the second major surface cleaning device 137b. Although not shown, the first major surface cleaning device 137a may be different than the second major surface cleaning device 137b in further embodiments.

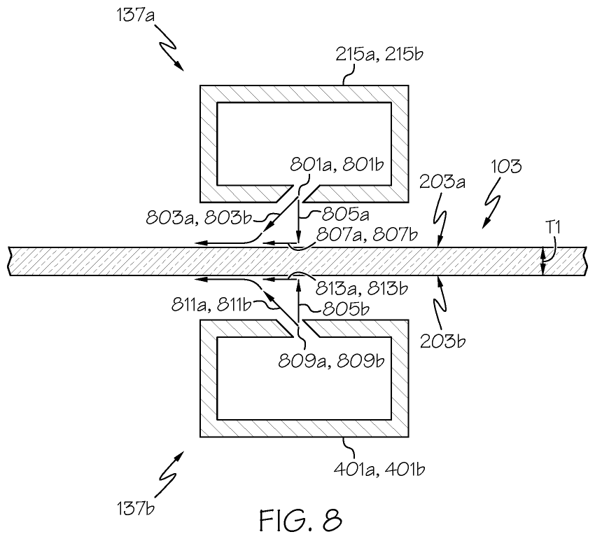

As shown in FIG. 3, the first major surface cleaning device 137a may include a first gas knife segment 215a. In further embodiments, the first major surface cleaning device 137a may further include a second gas knife segment 215b. As shown in FIG. 8, the first and second gas knife segment 215a, 215b can each include a corresponding first and second gas knife port 801a, 801b. The first gas knife port 801a of the first gas knife segment 215a faces a first gas knife direction that is a first resultant vector 803a of a first surface vector 805a extending towards the first major surface 203a and perpendicularly to the first major surface 203a and a second surface vector 807a that is perpendicular to the first surface vector 805a and that extends toward the first edge 201a, wherein the second surface vector 807a intersects, at a first acute angle “A1”, a line parallel to the first edge 201a. Similarly, the second gas knife port 801b of the second gas knife segment 215b faces a second gas knife direction that is a second resultant vector 803b of the first surface vector 805a extending towards the first major surface 203a and perpendicularly to the first major surface 203a and a second surface vector 807b that is perpendicular to the first surface vector 805a and that extends toward the second edge 201b, wherein the second surface vector 807b intersects, at a second acute angle “A2”, a line parallel to the second edge 201b.

As shown in FIG. 4, the second major surface cleaning device 137b may include a first gas knife segment 401a that may be similar or identical to the first gas knife segment 215a of the first major surface cleaning device 137a. In further embodiments, the second major surface cleaning device 137b may further include a second gas knife segment 401b that may be similar or identical to the second gas knife segment 215b of the first major surface cleaning device 137a. As shown in FIG. 8, the first and second gas knife segment 401a, 401b can each include a corresponding first and second gas knife port 809a, 809b. The first gas knife port 809a of the first gas knife segment 401a faces a first gas knife direction that is a first resultant vector 811a of a first surface vector 805b extending towards the second major surface 203b and perpendicularly to the second major surface 203b and a second surface vector 813a that is perpendicular to the first surface vector 805b and that extends toward the first edge 201a, wherein the second surface vector 813a intersects, at a third acute angle “A3”, a line parallel to the first edge 201a. Similarly, the second gas knife port 809b of the second gas knife segment 401b faces a second gas knife direction that is a second resultant vector 811b of the first surface vector 805b extending towards the second major surface 203b and perpendicularly to the second major surface 203b and a second surface vector 813b that is perpendicular to the first surface vector 805b and that extends toward the second edge 201b, wherein the second surface vector 813b intersects, at a fourth acute angle “A4”, a line parallel to the second edge 201b. The acute angles A1, A2, A3, A4 may be identical or different from one another. In some embodiments, the acute angles A1, A2, A3, A4 may be from about 10° to about 80°, from about 20° to about 70°, from about 30° to about 60°, about 45°, or other angles.

Referring to FIG. 3, the first gas knife port 801a of the first gas knife segment 215a of the first major surface cleaning device 137a may extend along a first gas knife axis 216a. Likewise, the second gas knife port 801b of the second gas knife segment 215b of the first major surface cleaning device 137a may extend along a second gas knife axis 216b. As shown in FIG. 3, the first gas knife axis 216a may intersect the second gas knife axis 216b with an interior angle “B1” of from greater than 0° to less than 180° defined between the first gas knife axis 216a and the second gas knife axis 216b. As shown, the interior angle “B1” can face the downstream direction that is the travel direction 202a of a conveyance path defined by the web conveyance apparatus 101.

Referring to FIG. 4, the first gas knife port 809a of the first gas knife segment 401a of the second major surface cleaning device 137b may extend along a first gas knife axis 402a. Likewise, the second gas knife port 809b of the second gas knife segment 401b of the second major surface cleaning device 137b may extend along a second gas knife axis 402b. As shown in FIG. 4, the first gas knife axis 402a may intersect the second gas knife axis 402b with an interior angle “B2” of from greater than 0° to less than 180° defined between the first gas knife axis 402a and the second gas knife axis 402b. As shown, the interior angle “B2” can face the downstream direction that is the travel direction 202a of a conveyance path defined by the web conveyance apparatus 101. In some embodiments, the interior angle B1 may be identical to the interior angle B2 although different interior angles may be provided in further embodiments.

In some embodiments, as shown, the interior angles B1 and B2 both face the downstream direction that is the travel direction 202a while gas from the air knife ports 801a-b, 809a-b face upstream and at an angle such that the air streams act as a plow to force particles to move toward one of the first edge 201a or the second edge 201b to be suctioned by a corresponding exterior suction port 211, 213 associated with the first and second edges 201a-b as the web 103 travels along the travel direction 202a.

In some embodiments, the web conveyance apparatus 101 can further include a second cleaning device 143 including an interior suction port laterally positioned between the first edge 201a and the second edge 201b. In some embodiments, the second cleaning device 143 may include a first portion 145a including an interior suction port laterally positioned between the first edge 201a and the second edge 201b within the footprint 204a of the first major surface 203a. In further embodiments, the second cleaning device 143 may include a second portion 145b including an interior suction port laterally positioned between the first edge 201a and the second edge 201b within the footprint 204b of the second major surface 203b. As shown in FIG. 1, in some embodiments, the second cleaning device 143 may be positioned upstream relative to the first cleaning device 136. In such examples, the second cleaning device 143 may be designed to remove relatively large particles from the first major surface 203a and/or the second major surface 203b and then the first cleaning device 136 may subsequently remove relatively small particles from the first major surface 203a and/or the second major surface 203b that were not removed by the second cleaning device 143.

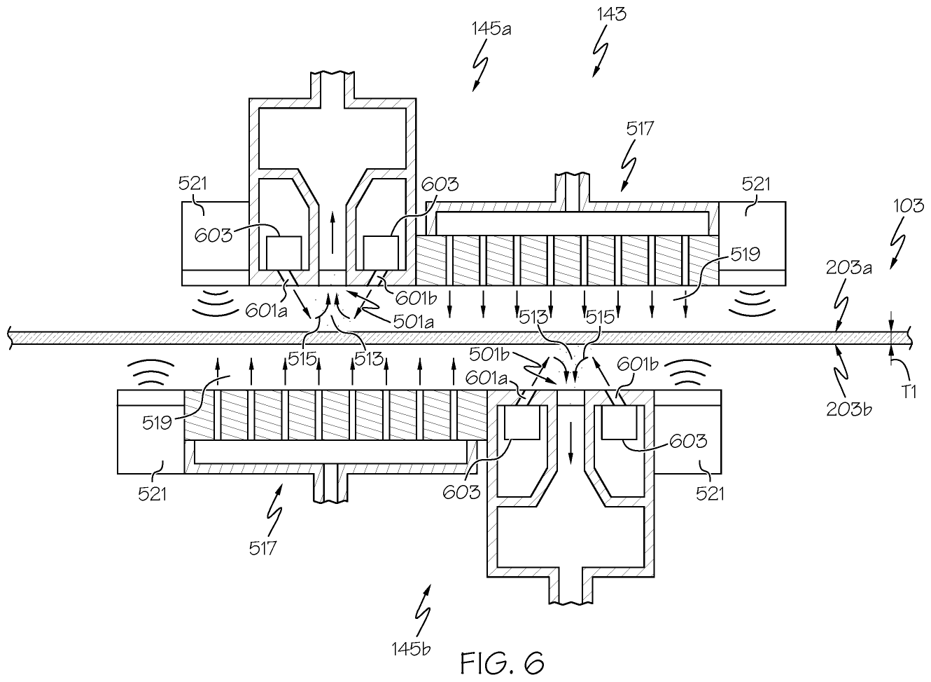

A wide range of second cleaning devices 143 may be used in accordance with aspects of the disclosure. FIGS. 5 and 6 illustrated two alternative embodiments of second cleaning devices 143 that may be used in accordance with aspects of the disclosure. As shown, each of the second cleaning devices 143 can include a first portion 145a and a second portion 145b that each include an interior suction port 501a-b. The interior suction port 501a of the first portion 145a is laterally positioned between the first edge 201a and the second edge 201b within the footprint 204a of the first major surface 203a. Likewise, the interior suction port 501b of the second portion 145b is laterally positioned between the first edge 201a and the second edge 201b within the footprint 204b of the second major surface 203b.

The embodiment of FIG. 5 can include a rotating arm 503 that may be rotated by a motor 504 with a shaft 505 in a rotation direction 507. End portions 509a, 509b of the rotating arm can emit gas jets 511a, 511b that move relatively large particles 513 from or along the surface so that they are able to be suctioned along suction path 515 into the interior suction ports 501a-b.

The embodiment of FIG. 6 can include jet knives 601a-b that emit gas jets that move relatively large particles 513 from or along the surface so that they are able to be suctioned along suction path 515 into the interior suction ports 501a-b. In some embodiments, ultrasonic energy may be introduced by generators 603 to help excite and thereby separate the large particles 513 from the corresponding major surfaces 203a-b of the web 103.

In further embodiments, for example the second cleaning devices 143 of FIGS. 5 and 6, air bars 517 may be designed to produce a cushion of gas 519 to provide support for the gas jets and/or jet knives without contacting the web, thereby providing desired support without damaging the web. In further embodiments, static neutralizing devices 521 may be provided to neutralize static charge that may exist on the web and/or particles to help prevent attraction of the particles to the web and thereby facilitate removal of the particles from the major surface of the web.

Methods of manufacturing a web 103 will now be described. The web 103 includes the first edge 201a, the second edge 201b, the first major surface 203a extending between the first edge 201a and the second edge 201b. The web 103 further includes the second major surface 203b extending between the first edge 201a and the second edge 201b. The web 103 includes the width “W” defined between the first edge 201a and the second edge 201b and the thickness “T1” defined between the first major surface 203a and the second major surface 203b. The method may include conveying the web 103 along a travel direction 202a of a conveyance path.

In some embodiments, the method can include suctioning particles from the first major surface 203a with the first exterior suction port 211 laterally positioned outside of the first edge 201a and facing the footprint 204a of the first major surface 203a while conveying the web 103. In some embodiments, prior to suctioning the particles from the first major surface 203a with the first exterior suction port 211, the method can include separating the particles from the first major surface 203a with a first knife of gas facing a first gas knife direction that is a first resultant vector 803a of a first surface vector 805a extending towards the first major surface 203a and perpendicularly to the first major surface 203a and a second surface vector 807a that is perpendicular to the first surface vector 805a and that extends toward the first edge 201a, wherein the second surface vector 807a intersects, at a first acute angle “A1”, a line parallel to the first edge 201a. As such, the angle of the first knife of gas can separate particles from the first major surface 203a and sweep the particles upstream, opposite the travel direction 202a, and laterally toward the first edge 201a to be received by the first exterior suction port 211 positioned along the travel path of the first knife entrained with particles removed from the first major surface 203a.

The method may also include suctioning particles from the second major surface 203b with the first exterior suction port 211 laterally positioned outside of the first edge 201a and facing the footprint 204b of the second major surface 203b while conveying the web 103. In some embodiments, suctioning of the particles from the first major surface 203a and the suctioning of additional particles from the second major surface 203b are conducted simultaneously with the first exterior suction port 211. In some embodiments, prior to suctioning the particles from the second major surface 203b with the first exterior suction port 211, the method can include separating the particles from the second major surface 203b with a first knife of gas facing a first gas knife direction that is a first resultant vector 811a of a first surface vector 805b extending towards the second major surface 203b and perpendicularly to the second major surface 203b and a second surface vector 813a that is perpendicular to the first surface vector 805b and that extends toward the first edge 201a, wherein the second surface vector 813a intersects, at a third acute angle “A3”, a line parallel to the first edge 201a. As such, the angle of the first knife of gas can separate particles from the second major surface 203b and sweep the particles upstream, opposite the travel direction 202a, and laterally toward the first edge 201a to be received by the first exterior suction port 211 positioned along the travel path of the first knife entrained with particles removed from the second major surface 203b. Further, the surface vector 805a perpendicular to the first major surface 203a counters the surface vector 805b perpendicular to the second major surface 203b. Consequently, the surfaces vectors 805a, 805b of the first resultant vectors 803a, 811a can provide a counterbalance stabilizing force to the web 103.

In some embodiments, the method can include suctioning additional particles from the first major surface 203a with a second exterior suction port 213 laterally positioned outside of the second edge 201b and facing the footprint 204a of the first major surface 203a while conveying the web 103. In some embodiments, prior to suctioning the particles from the first major surface 203a with the second exterior suction port 213, the method can include separating the particles from the first major surface 203a with a second knife of gas facing a second gas knife direction that is a second resultant vector 803b of the first surface vector 805a extending towards the first major surface 203a and perpendicular to the first major surface 203a and a second surface vector 807b that is perpendicular to the first surface vector 805a and that extends toward the second edge 201b, wherein the second surface vector 807b intersects, at a second acute angle “A2”, a line parallel to the second edge 201a. As such, the angle of the second knife of gas can separate particles from the first major surface 203a and sweep the particles upstream, opposite the travel direction 202a, and laterally toward the second edge 201b to be received by the second exterior suction port 213 positioned along the travel path of the first knife entrained with particles removed from the first major surface 203a.

In some embodiments, the method can include suctioning additional particles from the second major surface 203b with the second exterior suction port 213 laterally positioned outside of the second edge 201b facing the footprint 204b of the second major surface 203b while conveying the web 103. In some embodiments, suctioning of the particles from the first major surface 203a and the suctioning of additional particles from the second major surface 203b are conducted simultaneously with the second exterior suction port 213. In some embodiments, prior to suctioning the particles from the second major surface 203b with the second exterior suction port 213, the method can include separating the particles from the second major surface 203b with a second knife of gas facing a second gas knife direction that is a second resultant vector 811b of the first surface vector 805b extending towards the second major surface 203b and perpendicularly to the second major surface 203b and a second surface vector 813b that is perpendicular to the first surface vector 805b and that extends toward the second edge 201b, wherein the second surface vector 813b intersects, at a fourth acute angle “A4”, a line parallel to the second edge 201b. As such, the angle of the second knife of gas can separate particles from the second major surface 203b and sweep the particles upstream, opposite the travel direction 202a, and laterally toward the second edge 201b to be received by the second exterior suction port 213 positioned along the travel path of the second knife entrained with particles removed from the second major surface 203b. Further, the surface vector 805a perpendicular to the first major surface 203a counters the surface vector 805b perpendicular to the second major surface 203b. Consequently, the surfaces vectors 805a, 805b of the first resultant vectors 803a, 811a can provide a counterbalance stabilizing force to the web 103.

In further embodiments, methods of manufacturing a web 103 can include suctioning particles with an interior suction port either before or after suctioning particles from the web with an exterior suction port (e.g., exterior suction ports 211, 213). In one embodiment, the method can convey the web 103 along the direction 202a. Then the method can include suctioning particles from a portion of the web 103 with the interior suction port 501a laterally positioned between the first edge 201a and the second edge 201b within the footprint 204a of the first major surface 203a while conveying the web 103 along the direction 202a of the conveyance path. In further embodiments, the method can include suctioning particles from a portion of the web 103 with the interior suction port 501b laterally positioned between the first edge 201a and the second edge 201b within the footprint 204b of the second major surface 203b while conveying the web 103 along the direction 202a of the conveyance path. In some embodiments, gas jets 511a, 511b or jet knives 601a, 601b may be used to separate particles from the respective major surfaces of the web to be received by the interior suction ports. The web can then be further conveyed along the direction 202a of the conveyance path to the zone including the exterior suction ports 211, 213 discussed above. In some embodiments, the gas knife segments 215a, 215b, 401a, 401b may be provided to help dislodge particles from the major surfaces of the web and direct the entrained particles toward the exterior suction ports 211, 213 where the additional particles entrained in the gas streams from the gas knife segments are suctioned with the exterior suction port 211, 213.

In some embodiments, prior to suctioning the particles from the web 103, the method can include separating an edge portion 205a, 205b of the web to create the first edge 201a and the second edge 201b. Particles generated during the process of separating the edge portions 205a, 205b can then be suctioned by the exterior suction ports 211, 213 and in some embodiments, the interior suction ports 501a, 501b as well.

In any of the embodiments, the method can further optionally include the step of neutralizing a static charge of at least one of the web 103 and the particles to help prevent attachment of the particles to one of the major surfaces of the web 103 and further prevent static charge from inhibiting the flow of particles to be suctioned by interior or exterior suction ports.

Methods of the disclosure can be applied to a web comprising glass although the method may be carried out with a web comprising a wide variety of materials, for example, silicon, plastic, resin, ceramic, glass-ceramic, or other materials. In some embodiments, the thickness of the web can be from about 50 microns to about 500 microns or from about 50 microns to about 300 microns. For instance, in some embodiments, the web 103 may have a thickness of ≤500 microns, ≤300 microns, ≤200 microns, or ≤100 microns.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, such as within about 5% of each other, or within about 2% of each other.

The above embodiments, and the features of those embodiments, are exemplary and can be provided alone or in any combination with any one or more features of other embodiments provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of this disclosure provided they come within the scope of the appended claims and their equivalents.

1. A web conveyance apparatus comprising:
a web conveyance path comprising a first edge, a second edge, a first major surface extending between the first edge and the second edge, a second major surface extending between the first edge and the second edge, a width defined between the first edge and the second edge, and a thickness defined between the first major surface and the second major surface; and
a first cleaning device comprising a first exterior suction port laterally positioned outside of the first edge and facing a footprint of the first major surface.

2. The web conveyance apparatus of claim 1, the first cleaning device further comprises a second exterior suction port laterally positioned outside of the second edge and facing the footprint of the first major surface.

3. The web conveyance apparatus of claim 1, the first cleaning device further comprises a first gas knife segment comprising a first gas knife port facing a first gas knife direction that is a first resultant vector of a first surface vector extending towards the first major surface and perpendicularly to the first major surface and a second surface vector that is perpendicular to the first surface vector and extends toward the first edge, and the second surface vector intersects, at a first acute angle, a line parallel to the first edge.

4. The web conveyance apparatus of claim 3, the first cleaning device further comprises a second gas knife segment comprising a second gas knife port facing a second gas knife direction that is a second resultant vector of the first surface vector and a third surface vector that is perpendicular to the first surface vector and extends toward the second edge, and the third surface vector intersects, at a second acute angle, a line parallel to the second edge.

5. The web conveyance apparatus of claim 1, the first cleaning device further comprises a first gas knife segment comprising a first gas knife port extending along a first gas knife axis, and a second gas knife segment comprising a second gas knife port extending along a second gas knife axis, and an interior angle of from greater than 0° to less than 180° is defined between the first gas knife axis and the second gas knife axis.

6. The web conveyance apparatus of claim 5, the interior angle faces a downstream direction of a conveyance path defined by the web conveyance apparatus.

7. The web conveyance apparatus of claim 1, the first exterior suction port comprises a plurality of first exterior suction ports extending along the first edge.

8. The web conveyance apparatus of claim 7, each suction port of the plurality of first exterior suction ports is positioned on a common axis that is parallel to the first edge and laterally offset outside of the first edge.

9. The web conveyance apparatus of claim 1, a lateral footprint of a length of the first edge is positioned entirely within a footprint of the first exterior suction port.

10. The web conveyance apparatus of claim 1, further comprising a second cleaning device comprising an interior suction port laterally positioned between the first edge and the second edge within the footprint of the first major surface.

11. The web conveyance apparatus of claim 1, further comprising a static neutralizing device positioned to neutralize a static charge of at least one of the web and particles on the first major surface of the web.

12. The web conveyance apparatus of claim 1, the web comprises glass.

13. The web conveyance apparatus of claim 1, the thickness of the web is from about 50 microns to about 300 microns.

14. A method of conveying a web comprising a first edge, a second edge, a first major surface extending between the first edge and the second edge, a second major surface extending between the first edge and the second edge, a width defined between the first edge and the second edge, and a thickness defined between the first major surface and the second major surface comprising:
conveying the web along a direction of a conveyance path; and
suctioning particles from the first major surface, with a first exterior suction port laterally positioned outside of the first edge and facing a footprint of the first major surface, while conveying the web.

15. The method of claim 14, further comprising suctioning additional particles from the first major surface, with a second exterior suction port laterally positioned outside of the second edge and facing the footprint of the first major surface, while conveying the web.

16. The method of claim 14, where, prior to suctioning the particles, separating the particles from the first major surface with a first knife of gas, the first knife of gas facing a first gas knife direction that is a first resultant vector of a first surface vector extending towards the first major surface and perpendicularly to the first major surface and a second surface vector that is perpendicular to the first surface vector and that extends toward the first edge, and the second surface vector intersects, at a first acute angle, a line parallel to the first edge.

17. The method of claim 16, where, prior to suctioning the additional particles, separating the additional particles from the first major surface with a second knife of gas, the second knife of gas facing a second gas knife direction that is a second resultant vector of the first surface vector and a third surface vector that is perpendicular to the first surface vector and that extends toward the second edge, and the third surface vector intersects, at a second acute angle, a line parallel to the second edge.

18. The method of claim 14, further comprising suctioning additional particles from the second major surface.

19. The method of claim 18, the suctioning of the particles from the first major surface and the suctioning of additional particles from the second major surface are conducted simultaneously with the first exterior suction port.

20. The method of claim 14, further comprising neutralizing a static charge of at least one of the web and the particles.

21-24. (canceled)
